(19) United States
(12) Patent Application Publication
(10) Pub. No.: US 2026/0133330 A1
(43) Pub. Date: May 14, 2026

(54) HYDROPHONE AND ASSEMBLING METHOD

(71) Applicant: SERCEL, Carquefou (FR)

(72) Inventors: Christophe AUGOR, Carquefou (FR); Louis GUILLOU, Carquefou (FR); Benoit GODET, Carquefou (FR)

(21) Appl. No.: 18/945,891

(22) Filed: Nov. 13, 2024

(51) Int. Cl. G01V 1/18; G01V 1/16

(52) U.S. Cl. CPC G01V 1/186; G01V 1/164

(57) ABSTRACT

A hydrophone for measuring an ambient water pressure includes a base, a sensor and electronics module configured to measure the ambient water pressure, and a spacer configured to be attached with a first end to the base and with a second end to the sensor and electronics module so that a chamber is formed between the base and the sensor and electronics module. The spacer axially aligns a longitudinal axis (X_{B}) of the base with a longitudinal axis (X_{M}) of the sensor and electronics module.

### BACKGROUND

### Technical Field

Embodiments of the subject matter disclosed herein generally relate to systems and methods for monitoring seismic waves in a marine environment and, more particularly, to a hydrophone that prevents moisture from entering its electronics when used with an ocean bottom node for collecting seismic data, and method for assembling the hydrophone.

### Discussion of the Background

Marine seismic surveying investigates and maps the structure and character of geological formations under a body of water using reflection seismology. Reflection seismology is a method of geophysical exploration especially helpful in the oil and gas industry, but also works for other resources. In marine reflection seismology, the depth and the horizontal location of features causing reflections of seismic waves are evaluated by measuring the time it takes for the seismic wave to travel to receivers. These features may be associated with subterranean geological features that are indicative of hydrocarbon reservoirs.

A typical marine seismic surveying system is illustrated in FIG. 1. A vessel 100 tows a seismic source 102 and optionally plural streamers 106, each streamer carrying an array of seismic sensor groups 104 (e.g., a sensor group 104 includes one or more individual sensors, e.g., hydrophones, geophones, accelerometers, etc., and plural individual sensors are wired together to form the sensor group 104; although each individual sensor measures a corresponding signal, the signals from a sensor group 104 are combined together, at the streamer level, so that a sensor group 104 outputs a single trace). Alternatively, the vessel 100 may tow only the seismic source 102. No matter which configuration is selected for the vessel, plural ocean bottom nodes (OBNs) 150 are stationary distributed on the ocean bottom 120.

The seismic source 102 is configured to generate a seismic wave 110 that propagates downward (down, up, and vertical being defined relative to gravity) toward the seafloor 120 and penetrates formations 125 under seafloor 120 until it is eventually reflected at impedance discontinuity locations such as 122a and 122b. While locations 122a and 122b are shown in the figure as being interfaces between different subsurface layers, these locations may also be associated with a geological feature, for example, a fault line. The reflected seismic waves 130A and 130B propagate upwardly and can be detected by the OBNs 150 or, by sensor groups 104 (if streamers are used). Based on the data collected by OBNs 150 or sensor groups 104, an image of the subsurface formation is generated by further analyses of the collected data. Note that all data collected by OBNs 150 or sensor groups 104 is transmitted to a global controller 101 of vessel 100.

The OBN 150 is shown in FIG. 2 having a housing 252 that houses a hydrophone 254 for detecting a pressure wave, a processor 256 for processing the detected waves, a memory 258 for storing the seismic data and processing software, and a power source 260 for providing electrical power to these components. Optionally, the OBN 150 may also include additional sensors 262, for example, accelerometers. The OBN 150 may also include a port 264, which is configured to transfer power and/or data with a receiving station (not shown). The port 264 may include wireless transmission means for transferring the data stored in the memory 258, in a wireless manner, to the receiving station, which is land based or vessel based. The OBN 150 may also include at least one controller 220 and processing electronics 222. The controller 220 and electronics 222 are configured to digitize the data from the sensors. The generated signal is later transmitted to a land facility for further processing and for eventually generating the image of the surveyed subsurface. While the hydrophone 254 may be directly exposed to the ambient (i.e., ocean water), all the other components are sealed inside the housing 252. An example of such OBN 150 is disclosed in patent application Ser. No. 18/343,079, filed on Jun. 28, 2023, and entitled “Quick Latch Seismic Data Acquisition Ocean Bottom Node and Method” and/or Patent Application Publication No. 2023/0168400, Filed on May 5, 2021, and entitled “Hybrid Seismic Data Acquisition Device and Corresponding Methods,” both of which are assigned to the assignee of the present document.

As the hydrophones 254 of the OBNs 150 are distributed on the ocean bottom, they are prone to absorb ambient moisture, which might negatively impact the electronics associated with each hydrophone. This might happens in spite of a protective layer that is provided along the hydrophone because some of the internal components of the hydrophone are radially misaligned, and thus, a thickness of the protective layer is not uniform. Therefore, there is a need for a method and hydrophone that can be safely deployed in water and, at the same time, is easy to be assembled.

### BRIEF SUMMARY OF THE INVENTION

A new hydrophone is introduced that is more resistant to water vapor infiltration. An associated method for assembling the hydrophone offers a more accurate alignment process of various components and a better seal for the electronics.

Thus, according to an embodiment, there is a hydrophone for measuring an ambient water pressure, and the hydrophone includes a base, a sensor and electronics module configured to measure the ambient water pressure, and a spacer configured to be attached with a first end to the base and with a second end to the sensor and electronics module so that a chamber is formed between the base and the sensor and electronics module. The spacer axially aligns a longitudinal axis (X_{B}) of the base with a longitudinal axis (X_{M}) of the sensor and electronics module.

According to another embodiment, there is a hydrophone for measuring ambient water pressure, and the hydrophone includes a base, a piezoelectric element configured to measure the ambient water pressure, a first lid configured to close a first end of the piezoelectric element, and a spacer configured to be attached with a first end to the base and with a second end to the first lid so that a chamber is formed between the base and the first lid. The spacer axially aligns a longitudinal axis (X_{B}) of the base with a longitudinal axis (X_{M}) of the first lid.

According to yet another embodiment, there is a method for assembling a hydrophone, and the method includes clipping a first end of a spacer to a base, clipping a second end of the spacer to a first lid to form a chamber between the base and the first lid, and filling with a first molding product the entire chamber to prevent moisture entering the chamber.

### BRIEF DESCRIPTION OF THE DRAWINGS

For a more complete understanding of the present invention, reference is now made to the following descriptions taken in conjunction with the accompanying drawings, in which:

FIG. 1 is a schematic diagram of a conventional ocean bottom seismic surveying system;

FIG. 2 illustrates a cross-section of an ocean bottom node having a hydrophone;

FIGS. 3A and 3B illustrate a hydrophone having a single molding product that may inaccurately align a sensor relative to a base;

FIGS. 4A to 4C illustrate a hydrophone in which a spacer is used to align the sensor relative to the base;

FIG. 5 is a cross section of the hydrophone having the spacer for aligning the sensor relative to the base;

FIG. 6 is a schematic diagram of a part of the hydrophone showing opposite forces experienced by a piezoelectric element and one of its lids due to thermal expansion;

FIGS. 7A and 7B illustrate a structure of the lids for being attached to the piezoelectric element;

FIG. 8 is a flow chart of a method for assembling the hydrophone of FIGS. 4A to 5; and

FIG. 9A schematically illustrates the various components of the hydrophone before being assembled and FIG. 9B illustrates the assembled hydrophone.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of a hydrophone used in marine seismic surveying. However, the embodiments to be discussed next are not limited to marine seismic surveying, but may be applied to any cable or device that uses hydrophones.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

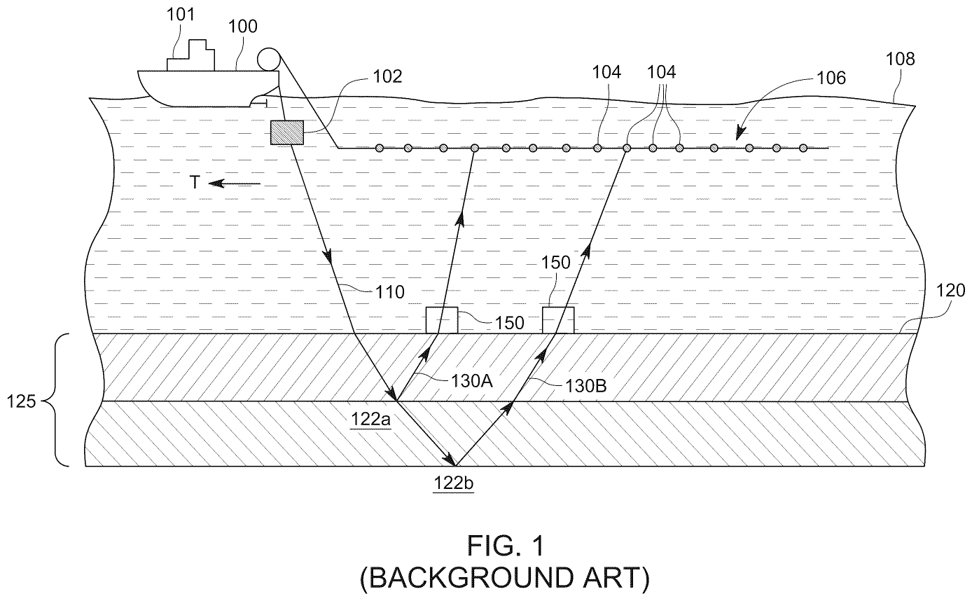

The hydrophones distributed along the ocean bottom during a seismic survey are used for determining a quantity (e.g., pressure) that is a direct consequence of the acoustic waves emitted by a seismic source (e.g., source 102 in FIG. 1) or a reflection/refraction of the acoustic waves from geological structure located in the subsurface. No matter the scenario, the hydrophones include a piezoelectric ceramic element having a tubular shape and this tubular ceramic element needs to be correctly positioned relative to its base for ensuring accurate measurements, and preventing moisture entering the ambient of the electronics.

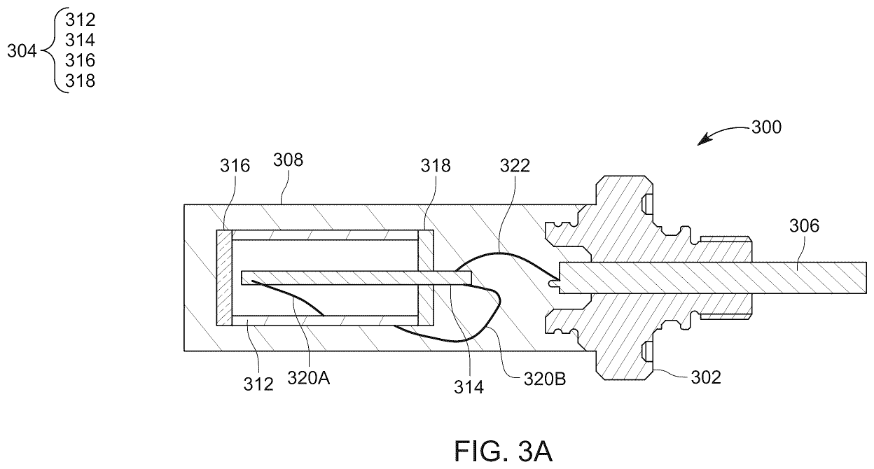

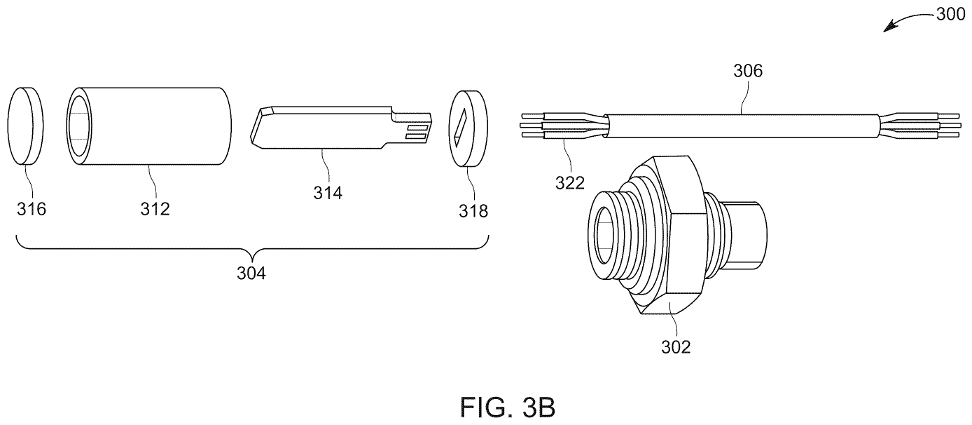

A hydrophone 300 is illustrated in FIGS. 3A and 3B and includes a base 302, which may be made of Aluminum, a sensor and electronics module 304, an electrical cable 306 that electrically connects to the sensor and electronics module 304, and a shell 308 that fully encloses the sensor and electronics module 304 for preventing water moisture reaching the electronics inside the module. The sensor and electronics module 304 includes a piezoelectric (ceramic) tubular element 312 that encloses a printed circuit board 314. A top lid 316 and a bottom lid 318 close the ends of the tubular element 312 so that the printed circuit board 314 is screened from the outside moisture. Electrical wires 320A and 320B connect the inner and outer surfaces of the tubular element 312 to the printed circuit board 314. Additional electrical wires 322, which are part of the cable 306, are also connected to the printed circuit board 314. The shell 308 fully encloses all the elements discussed above, as illustrated in FIG. 3A. FIG. 3B shows the hydrophone 300 having all its elements separated from each other.

A problem with the hydrophone 300 is that the shell 308 material, which is selected to be acoustically compatible with the ceramic tubular element 312, has the disadvantage of absorbing moisture when exposed to water over a certain period of time. Thus, there is a risk to product reliability if moisture reaches the electrical wires 320A, 320B, 322, or the printed circuit board 314. Note that between the sensor and electronics module 304 and the base 302 there is no other structure except for the shell 308.

In addition, the hydrophone 300 has no mechanical link between the ceramic tubular element 312 and the base 302, which means that centering and alignment between these two elements is difficult to ensure during the manufacturing process. If there is misalignment between these two elements, this can result in a shell thickness too thin on one side, for protecting the ceramic tubular element 312.

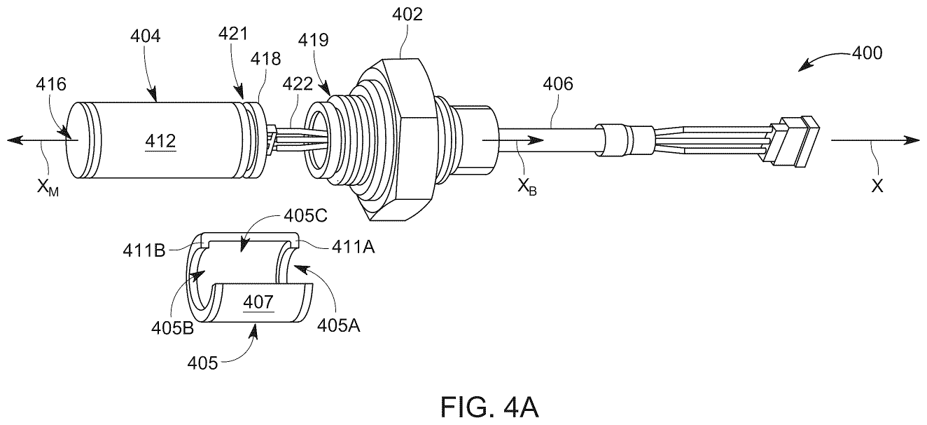

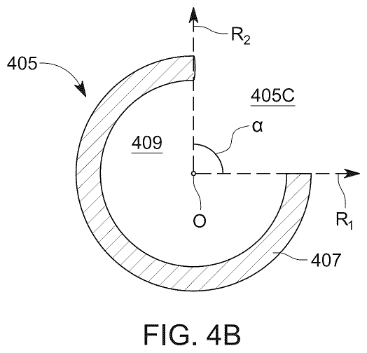

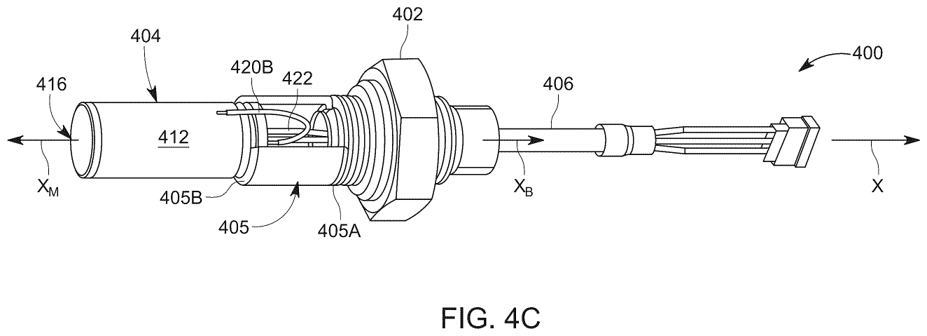

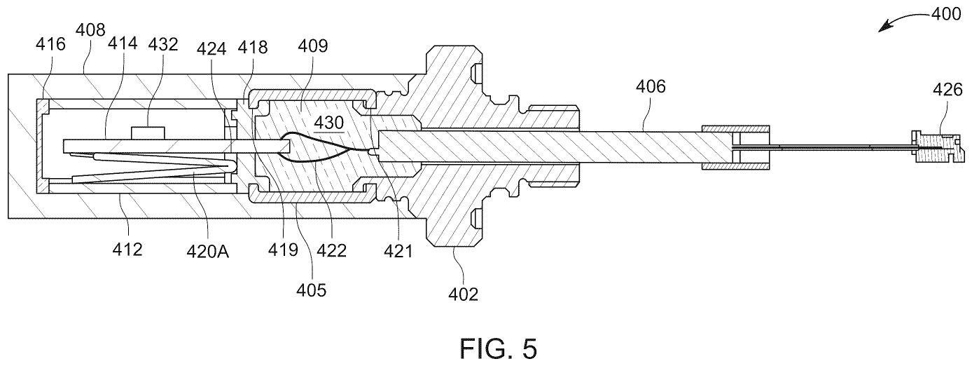

Thus, the inventors have discovered a new hydrophone configuration that avoids one or more of the disadvantages of the hydrophone 300 discussed above. This new hydrophone 400 is illustrated in FIGS. 4A to 5 and includes a base 402, a sensor and electronics module 404, and a spacer 405 that separates and mechanically connects to each other, along a longitudinal axis X, the base 402 and the sensor and electronics module 404. The hydrophone also includes a cable 406 for transferring power and/or information between a controller (e.g. processor 256) of the OBN 150, in which the hydrophone may be placed. The spacer 405 may be made of plastic or metallic material. FIG. 4B shows a cross-section of the spacer 405, illustrating the open nature of the spacer. In this respect, note that the spacer 405 is open not only at its ends 405A and 405B along the longitudinal axis X, as illustrated in FIG. 4A, but also along an entire side section 405C of its tubular wall 407. While FIG. 4B shows that the opening 405C is characterized by an angle α defined by radii R1 and R2 (which define the opening 405C), of about 90°, those skilled in the art would understand that this angle may vary with about +/−20%. The opening 405C is made in the wall 407 of the spacer 405 so that a user may fill a chamber 409, which is formed inside the spacer 405, with a molding product (e.g., filler paste or filler epoxy, etc.), which is discussed later in more detail. The molding product is selected to be any material that acts as a humidity barrier, e.g., an epoxy glue.

FIG. 4C shows the spacer 405 being attached with one end 405A to the base 402 and with the other end 405B to the sensor and electronics module 404. By providing this solid connection between the base 402 and the sensor and electronics module 404, it is possible to automatically radially align these two elements relative to each other, i.e., there is no need for human alignment of these two elements during the manufacturing process. In other words, the spacer 405 radially aligns a longitudinal axis X_{B} of the base 402 with a longitudinal axis X_{M} of the sensor and electronics module 404 (which is also the longitudinal axis of the lids). The longitudinal axis X_{B} of the base 402 is determined by the geometry of the base while the longitudinal axis X_{M} of the sensor and electronics module 404 is essentially dictated by the geometry of the piezoelectric element 412. In this respect, the sensor and electronics module 404 includes, in addition to the piezoelectric element 412, a printed circuit board and associated electronics.

The fact that the base 402 and the sensor and electronics module 404 are aligned to each other along the radial direction ensures that the addition of a second molding product (to be discussed later) around the elements attached to the spacer and the spacer itself, will have a guaranteed constant thickness, thus optimizing the waterproof characteristic of the hydrophone. In one application, the spacer 405 has end lips 411A and 411B (e.g., shoulders), which are configured to snap fit into corresponding grooves 419 and 421 of the base 402 and the sensor and electronics module 404, respectively. In this embodiment, the groove 419 is formed into an end of the base 402 while the groove 421 is formed into a first lid 418. The first lid 418, which is also illustrated in FIG. 5, is attached to one end of the piezoelectric element 412, which is part of the sensor and electronics module 404.

The sensor and electronics module 404 includes, in addition to the piezoelectric element 412, the first lid 418, a second lid 416, a printed circuit board 414, a wire 420A (see FIG. 5) connecting the printed circuit board 414 to an interior surface of the piezoelectric element 412, and a wire 420B (see FIG. 4C) connecting the printed circuit board 414 to an exterior surface of the piezoelectric element 412. Note that the second lid 416 fully seals the corresponding end of the piezoelectric element while the first lid 418 has one or more openings. In one application, the first lid 418 has a single opening (slot) 424, as discussed later.

FIG. 5 shows the chamber 409 defined by the spacer 405, the first lid 418, and the base 402, being filled with a molding product 430 so that no humidity reaches the electronics or wires. Note that the molding product 430 is added to the chamber 409 during the manufacturing process of the hydrophone 400, through the opening 405C of the spacer 405 and the molding product 430 may fully encapsulate the wires 422 of the cable 406. After the chamber 409 is filled with the molding product 430, the opening 405C in the spacer 405 may remain open. Thus, in one embodiment, a size of the opening 405C is selected so that the molding product can be inserted into the chamber 409 and the spacer 405 solidly engages with both the first lid 418 and the base 402.

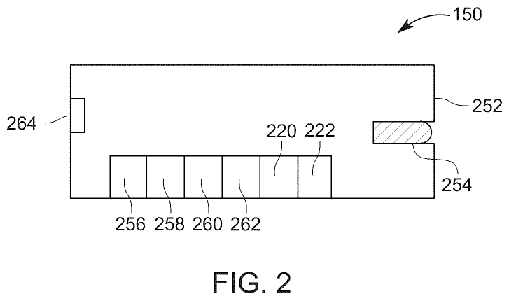

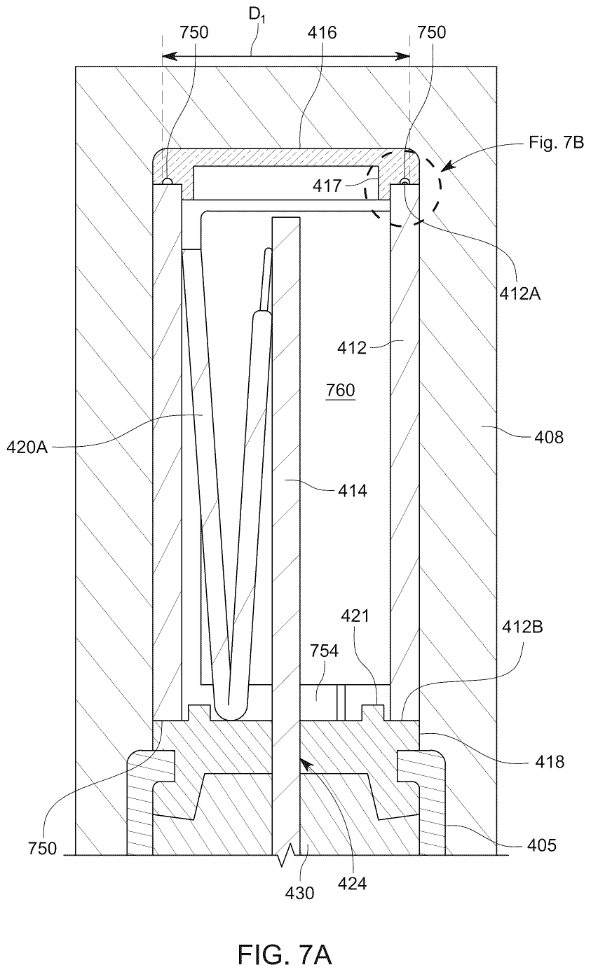

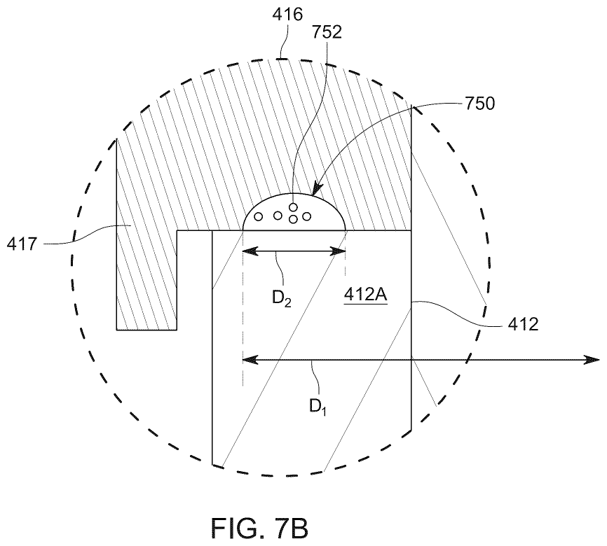

FIG. 5 also shows that the first lid 418 has a slot 424 that is sized to accept the printed circuit board 414 so that the printed circuit board partially extends inside the piezoelectric element 412 and partially extends inside the chamber 409. In one application, the slot 424 is manufactured to fit snugly around the printed circuit board 414 so that no other attachment or means is used to fix the printed circuit board to the first lid 418. In addition, as discussed later with regard to FIG. 7A, various shapes 754 may be formed on one surface of the first lid and these shapes are shaped and located to sandwich the printed circuit board, so that the printed circuit board does not oscillate during the operation of the OBN. FIG. 5 also shows that the cable 406 may be fitted with an electric connector 426, which may be connected to another hydrophone or another sensor, or to the electronics 222 or controller 220 of the OBN 150 shown in FIG. 2. As noted above, the hydrophone 400 may replace the hydrophone of the OBN 150.

The piezoelectric element 412 constitutes the element that is sensitive to the seismic waves. This element may be made of a piezoelectric ceramic, for example, lead zirconate titanate (PZT). Thus, a pressure exerted (indirectly) by the ambient water on the piezoelectric element 412, through the shell 408 (which is made of a second molding product to be discussed later), is translated into an electrical signal, which is sent to the printed circuit board 414, through wires 420A and 420B. The printed circuit board 414 may include electronics 432, for example, a pre-processing block. Other electronics known in the art may be present on the printed circuit board 414. These electronics may pre-process the recorded signal and then send it along cable 406 to the controller/processor 256 of the OBN 150 for further processing.

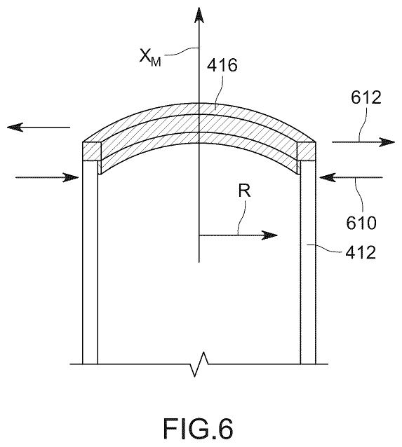

The material composition of the piezoelectric element 412 makes this element to have a negative coefficient of thermal expansion along a polarization direction. The polarization direction for the tubular piezoelectric element 412 is the radial direction R, as schematically illustrated in FIG. 6. This means that when the hydrophone 400 experiences a positive temperature change, the piezoelectric element 412 shrinks, as illustrated by arrow 610. However, the second lid 416 (the same is true for the first lid 418), for the same positive temperature change, experiences a size increase as shown by arrow 612, as the lids are made of materials that have positive coefficient of thermal expansion. This means that for any temperature change experienced by the hydrophone 400, the first and second lids change their diameters in one direction while the piezoelectric element 412 changes its diameter in the opposite direction. These opposing changes induce a tension or stress at the interfaces between the first and second lids 416, 418 and the piezoelectric element 412. Because the lids are glued to the piezoelectric element to prevent humidity from entering the inside, the stress is experienced by the glue, which in time may fail, thus resulting in moisture reaching the printed circuit board and its electronics inside the piezoelectric element 412.

This is a serious condition for a hydrophone, especially when deployed in the ocean for long periods of time as is the case for the OBN 150. Changing the hydrophones in an OBN is not only very expensive and time confusing, but also sometimes not feasible. Thus, to address this problem experienced by some of the current hydrophones, the inventors have designed the first and second lids 416 and 418 with grooves 750, as illustrated in FIGS. 7A and 7B. These grooves 750 are machined into the first and second lids so that they directly face the ends 412A and 412B of the piezoelectric element 412. FIG. 7B shows the second lid 416 having an inner lip (shoulder) 417, which extends around the inner circumference of the lid. The inner lip 417 is manufactured to have a diameter smaller than the inner diameter of the piezoelectric element 412 so that this lip guides the piezoelectric element 412 to contact the second lid so that the end 412A faces the groove 750. In one embodiment, the inner lip is sized to snugly fit the inside diameter of the piezoelectric element. The first lid 418 is also manufactured with a similar lip 421, as shown in FIG. 7A, to also guide the piezoelectric element 412. In this way, during the manufacturing process, the addition of the lids to the ends of the piezoelectric element 412 is more precise as the lips 417 and 421 do not allow the lids to be attached off center to the tubular piezoelectric element 412.

In one application, a bead of glue 752 is placed in the groove 750 to further enhance a contact between the lids and the piezoelectric element 412. The glue 752 may be selected to be flexible, i.e., to absorb the opposite displacement between the lids and the piezoelectric element when a temperature change occurs. The size of the groove 750 may be selected based on (1) a change in temperature from the product assembly environment to the product service environment, (2) the coefficient of thermal expansion of the glued parts, (3) the dimensions of the glued parts, and (4) a glue elongation at break. In one embodiment, the size of the groove is selected as follows. First, calculate the maximum displacement between the two glued parts, in this case, the first or second lid and the piezoelectric element. Then, calculate the estimated temperature change ΔT between the environment where the hydrophone is assembled (e.g., production facility) and the environment where the hydrophone is used (e.g., ocean bottom). Next, obtain/measure the thermal expansion coefficient, α₁, of the first part 416 or 418, and the thermal expansion coefficient, α₂, of the second part 412. Then, measure the external groove dimension D1 (see FIG. 7B). With these parameters, a displacement ε between the two glued parts is given by an absolute value of a difference between (1) the thermal expansion length of the first part multiplied by D1, and (2) the thermal expansion length of the second part multiplied by D1. If the thermal expansion coefficient is not constant over ΔT, its variation with the temperature needs to be taken into consideration. The glue groove dimension D2 of the groove 750 is then selected based on the calculated displacement ε so that an actual elongation of the glue is less than the maximum elongation of the glue.

FIG. 7A also shows protruding structures 754 from the first lid 418. In one embodiment, these structures 754 are located around the slot 424, to further fix the printed circuit board 414 relative to the lid. Note that the printed circuit board 414 is shown in FIG. 7A being surrounded by air 760. However, in one application, it is possible to replace the air 760 by a fluid, e.g., oil, a noble gas, etc.

Ensuring quality bonding between the ceramic element 412 and the lids 416 and 418 guarantee a certain reliability of the hydrophone 400, particularly in the transmission of acoustic waves to the ceramic element 412. If the adhesive 752 breaks, the acoustic waves are not fully transmitted to the ceramic, and the hydrophone loses some or all of its sensitivity. The arrangement shown in the figures also ensure a moisture barrier between the outside and inside of the piezoelectric element 412, thus, preventing short-circuits and protecting the printed circuit board and associated electronics.

The hydrophone 400 may be used to replace the hydrophone 254 of the OBN 150 illustrated in FIG. 2. Thus, the OBN 150 having the hydrophone 400 may replace the existing OBNs used today in some of the marine seismic surveys.

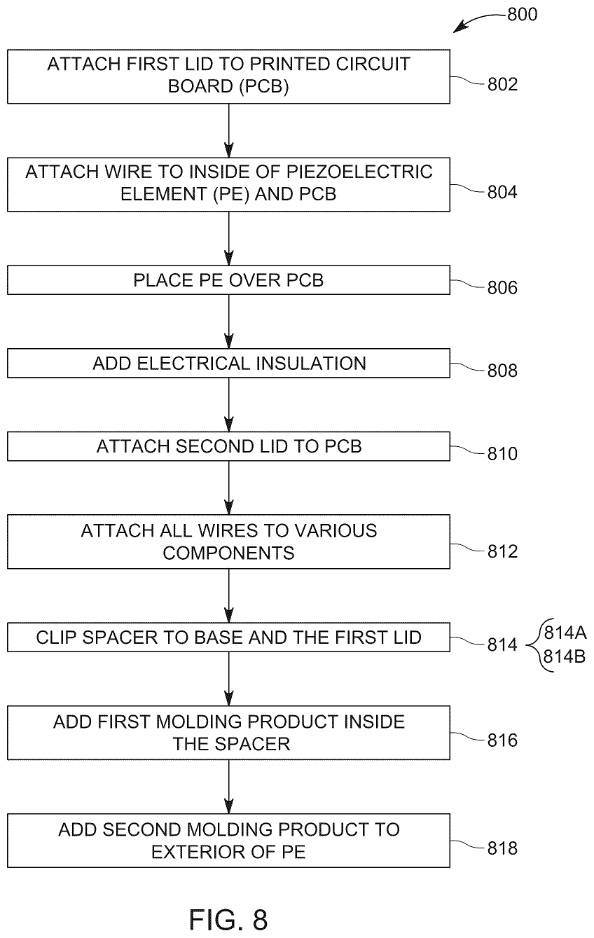

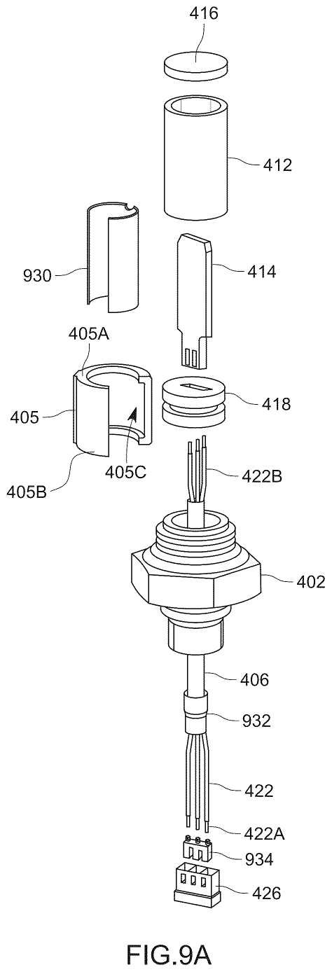

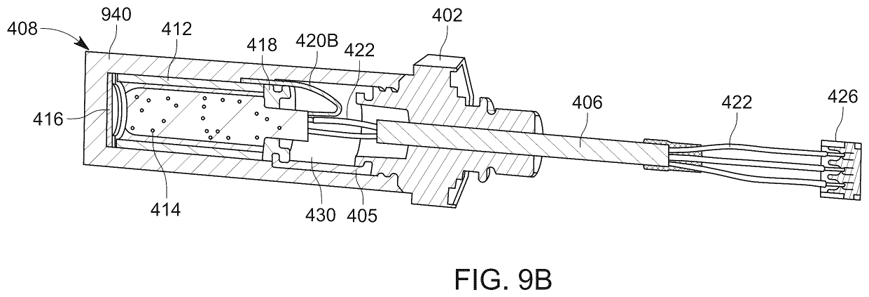

A method for assembling the hydrophone 400 is now discussed with regard to FIGS. 8, 9A, and 9B. FIG. 8 is a flow chart of the assembling method, FIG. 9A shows the various components of the hydrophone 400 in a disassembled state, and FIG. 9B shows the result of assembling these components according to the method of FIG. 8. The method 800 starts with step 802 of attaching (e.g., glueing but other means may also be used) the printed circuit board 414 to the first lid 418. Then, in step 804, the wire 420A (not visible in FIGS. 9A and 9B, but visible in FIG. 5) is attached between the printed circuit board 414 and an inside of the piezoelectric element 412. In step 806, the piezoelectric element 412 is placed over the printed circuit board 414 and fixedly attached (e.g., glueing or other similar means) to the first lid 418.

In step 808, an electrical insulation sheet 930 is inserted inside the piezoelectric element 412, around the printed circuit board 414, to electrically insulate the piezoelectric element from the printed circuit board. In step 810, the second lid 416 is attached (e.g., glueing, but other means may also be used) to the piezoelectric element 412. In step 812, a heat shrinking tube 932 is placed over the cable 406 and heat shrunk. During the same step, electrical contacts 934 are attached (e.g., welded) to the end 422A of the wires 422 belonging to the cable 406 and then the electrical contacts 936 are inserted into the electrical connector 426. Further, the cable 406 is inserted through the base 402 and then the ends 422B of the wires 422 are welded to the printed circuit board 414. Note that one end of the printed circuit board 414 extends past the first lid 418, which is already attached to the piezoelectric element 412 and thus, this end is accessible for welding. Step 812 concludes with welding the electrical wire 420B (shown in FIG. 9B) between an outside of the piezoelectric element 412 and the printed circuit board 414.

In step 814, the spacer 405 is clipped with one end 405A to the base 402 (substep 814A) and with another end 405B to the first lid 418 (substep 814B). Note that the base and the first and second lids are made of insulating materials, so that there is no electrical current leak between the various elements. In step 816, the first molding product 430 (not visible in FIG. 9A, but visible in FIG. 9B) is added inside the spacer 405, through its opening 405C, to fill the chamber 409. Note that the first molding product 430 may be any material that ensures a humidity barrier. In step 818, another molding product 940 (also called a second molding product) is placed over all the parts (of the sensor and electronics module 404) that extend away from the base 402, for example, spacer 405, first lid 418, piezoelectric element 412, and second lid 416. The second molding product 940 forms the shell 408. The second molding product 940, e.g. polyurethane, may be added to fully encapsulates elements 405, 418, 412, and 416. The second molding product may have a different chemical composition from the first molding product as a purpose of the second molding product is to provide acoustic transmission from the ambient water to the piezoelectric element 412, and also waterproofing of the assembly.

The disclosed embodiments provide a hydrophone that uses a spacer for creating a chamber in which a molding product is added to provide an enhanced humidity barrier between the electronics of the hydrophone and the ambient water. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims. REFERENCES
EP Ser. No. 02/975,432

What is claimed is:

1. A hydrophone for measuring an ambient water pressure, the hydrophone comprising:
a base;
a sensor and electronics module configured to measure the ambient water pressure; and
a spacer configured to be attached with a first end to the base and with a second end to the sensor and electronics module so that a chamber is formed between the base and the sensor and electronics module,
wherein the spacer axially aligns a longitudinal axis (X_{B}) of the base with a longitudinal axis (X_{M}) of the sensor and electronics module.

2. The hydrophone of claim 1, further comprising:
wires extending through the chamber, from the base to the sensor and electronics module; and
a first molding product filling the chamber to prevent moisture reaching the sensor and electronics module.

3. The hydrophone of claim 2, further comprising:
a second molding product fully enclosing the sensor and electronics module, the spacer, and a part of the base to prevent moisture reaching the sensor and electronics module.

4. The hydrophone of claim 3, wherein the second molding product is configured to transmit acoustic waves.

5. The hydrophone of claim 1, wherein the spacer has a cylindrical shape with a missing part of a side wall.

6. The hydrophone of claim 1, wherein the sensor and electronics module comprises:
a cylindrical piezoelectric element;
a first lid configured to be attached to a first end of the cylindrical piezoelectric element; and
a second lid configured to be attached to a second end of the cylindrical piezoelectric element,
wherein the second lid has no slots and the first lid has one slot.

7. The hydrophone of claim 6, wherein the first lid is directly attached to the spacer.

8. The hydrophone of claim 7, wherein each of the first lid and the base has a corresponding groove and the spacer has corresponding end lips so that the spacer end lips snap into the grooves of the first lid and the base.

9. The hydrophone of claim 6, wherein the sensor and electronics module further comprises:
a printed circuit board that partially extends into the cylindrical piezoelectric element and partially extends into the spacer, through the one slot of the first lid.

10. The hydrophone of claim 6, wherein at least one of the first and second lids has a groove directly facing a corresponding end of the piezoelectric element.

11. The hydrophone of claim 10, further comprising:
a glue placed in the groove between the piezoelectric element and the at least one of the first and second lids.

12. The hydrophone of claim 10, wherein the groove is sized based on (1) a change in temperature from a product assembly environment to a product service environment, (2) a coefficient of thermal expansion of each of the piezoelectric element and the at least one of the first and second lids, (3) dimensions of the piezoelectric element and the at least one of the first and second lids, and (4) a glue elongation at break.

13. The hydrophone of claim 6, wherein the piezoelectric element has a negative, radial, coefficient of thermal expansion and the first and second lids have a positive, radial, coefficient of thermal expansion.

14. The hydrophone of claim 6, wherein each of the first and second lids has an inner lip that is sized to snugly fit an internal diameter of the piezoelectric element.

15. A hydrophone for measuring ambient water pressure, the hydrophone comprising:
a base;
a piezoelectric element configured to measure the ambient water pressure;
a first lid configured to close a first end of the piezoelectric element; and
a spacer configured to be attached with a first end to the base and with a second end to the first lid so that a chamber is formed between the base and the first lid,
wherein the spacer axially aligns a longitudinal axis (X_{B}) of the base with a longitudinal axis (X_{M}) of the first lid.

16. The hydrophone of claim 15, further comprising:
a second lid configured to close a second end of the piezoelectric element;
wires extending through the chamber, from the base through the first lid; and
a first molding product filling the chamber to prevent moisture reaching an interior of the chamber.

17. The hydrophone of claim 16, further comprising:
a second molding product fully enclosing the piezoelectric element, the first lid, the second lid, the spacer, and a part of the base to prevent moisture reaching the piezoelectric element.

18. The hydrophone of claim 15, wherein each of the first lid and the base has a corresponding groove and the spacer has corresponding end lips so that the spacer end lips snap into the grooves of the first lid and the base.

19. A method for assembling a hydrophone, the method comprising:
clipping a first end of a spacer to a base;
clipping a second end of the spacer to a first lid to form a chamber between the base and the first lid; and
filling with a first molding product the entire chamber to prevent moisture entering the chamber.

20. The method of claim 19, further comprising:
adding a second molding product to an exterior of a sensor and electronics module, which is attached to the first lid, and partially to the base to fully encapsulate the sensor and electronics module to prevent the moisture entering the sensor and electronics module.
